(19) United States
(12) Patent Application Publication
(10) Pub. No.: US 2008/0026296 A1
(43) Pub. Date: Jan. 31, 2008

(54) Battery

(76) Inventors: William L. Bowden, Nashua, NH (US); Todd E. Bofinger, Shoreview, MN (US); David Leigh DeMuth, Maynard, MA (US); Rimma A. Sirotina, Ashland, MA (US)

Correspondence Address: FISH & RICHARDSON P.C., P.O. BOX 1022, MINNEAPOLIS, MN, 55440-1022, US

(21) Appl. No.: 11/494,725

(22) Filed: Jul. 27, 2006

(51) Int. Cl. H01M 10/40; H01M 4/40; H01M 4/58

(52) U.S. Cl. 429/329; 429/218.1; 429/231.95

(57) ABSTRACT

A battery includes an anode having a lithium alloy as the active material, a cathode having, for example, iron disulfide as the active material, and an electrolyte containing a sulfolane and 1,2-dimethoxyethane.

### TECHNICAL FIELD

The invention relates to batteries, as well as to related components and methods.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

One type of battery includes an alkali metal as the anode active material and iron disulfide as the cathode active material.

### SUMMARY

The invention relates to batteries having (1) an anode including an alkali metal; (2) a cathode including a cathode active material selected from the group consisting of transition metal polysulfides, such as iron disulfide, having the formula M1ₐM2_{b}Sₙ, wherein M1 and M2 are transition metals, a+b is at least 1, and n is at least 2×(a+b); and (3) an electrolyte including a sulfolane and 1,2-dimethoxyethane. The alkali metal preferably is a lithium alloy. In the transition metal polysulfide formula, M1 and M2 can be the same or different transition metals. When M1 and M2 are the same transition metal, b is zero. The batteries generally have good safety characteristics, limited gas evolution, and good high current discharge properties. The electrolyte preferably includes from 1% to 30% by volume of the sulfolane and from 35% to 99% by volume of the 1,2-dimethoxyethane.

Preferably, the electrolyte is substantially free of carbonate solvents. By substantially free, it is meant that the electrolyte includes less than 0.5% by weight of carbonate solvents.

Embodiments of the battery may include one or more of the following features. The electrolyte includes from 2% to 25% by volume of the sulfolane and at least 50% or 70% by volume of the 1,2-dimethoxyethane. The electrolyte includes less than 10% by volume (e.g., less than 5% by volume, less than 2% by volume, or less than 1% by volume) of a solvent other than the sulfolane and the 1,2-dimethoxyethane. The electrolyte has a viscosity of from 0.2 cps to 2.5 cps. The electrolyte also includes vinyl acetate (e.g., from 0.5% to 20% by volume of vinyl acetate).

In another aspect, the invention relates to batteries having (1) an anode including an alkali metal; (2) a cathode including a cathode active material such as iron disulfide selected from the group consisting of transition metal polysulfides, such as iron disulfide, having the formula M1ₐM2_{b}Sₙ, wherein M1 and M2 are transition metals, a+b is at least 1, and n is at least 2×(a+b); and (3) an electrolyte including a sulfolane and a lithium salt such as lithium bis(trifluoromethanesulfonyl)imide.

Other aspects of the invention relate to methods of using and making the batteries described above.

“A sulfolane”, as used herein, encompasses the molecule sulfolane as well as methyl, ethyl, and dimethyl sulfolane.

Other features and advantages will be apparent from the detailed description, the drawings, and from the claims.

### DESCRIPTION OF DRAWINGS

FIG. 1 is a sectional view of an embodiment of a non-aqueous electrochemical cell.

### DETAILED DESCRIPTION

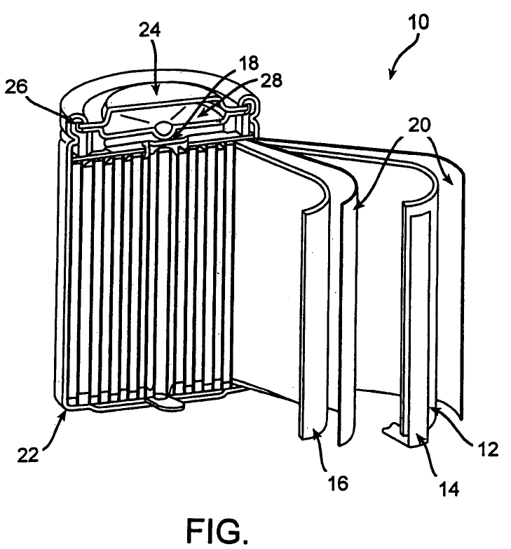

Referring to FIG. 1, a primary electrochemical cell 10 includes an anode 12 in electrical contact with a negative lead 14, a cathode 16 in electrical contact with a positive lead 18, a separator 20, and an electrolyte. Anode 12, cathode 16, separator 20, and the electrolyte are contained within a case 22. The electrolyte includes a sulfolane and 1,2-dimethoxyethane as solvents and a lithium salt that is at least partially dissolved in the solvent system. Electrochemical cell 10 further includes a cap 24 and an annular insulating gasket 26, as well as a safety valve 28.

Cathode 16 includes a cathode current collector and a cathode material that is coated on at least one side of the cathode current collector. The cathode material includes the cathode active material(s) and can also include one or more conductive materials (e.g., conductive aids, charge control agents) and/or one or more binders.

The cathode active material includes one or more transition metal polysulfide having the formula M1ₐM2_{b}Sₙ, wherein M1 and M2 are transition metals, a+b is at least 1, and n is at least 2×(a+b). In some embodiments, n is 2. In other embodiments, n is greater than 2.5 or 3.0. Examples of transition metals include cobalt, copper, nickel, and iron. Examples of transition metal polysulfides include CoS₂, NiS₂, MoS₂, Co₂S₉, Co₂S₇, Ni₂S₇, and Fe₂S₇, Mo₂S₃, and NiCoS₇. Transition metal polysulfides are described further, for example, in Bowden et al., U.S. Pat. No. 4,891,283 and Bowden et al., U.S. Pat. No. 4,481,267. The cathode material includes, for example, at least about 85% by weight and/or up to about 92% by weight of cathode active material.

The conductive materials can enhance the electronic conductivity of cathode 16 within electrochemical cell 10. Examples of conductive materials include conductive aids and charge control agents. Specific examples of conductive materials include carbon black, graphitized carbon black, acetylene black, and graphite. The cathode material includes, for example, at least about 3% by weight and up to about 8% by weight of one or more conductive materials.

The binders can help maintain homogeneity of the cathode material and can enhance the stability of the cathode. Examples of binders include linear di- and tri-block copolymers. Additional examples of binders include linear tri-block polymers cross-linked with melamine resin; ethylene-propylene copolymers; ethylene-propylene-diene terpolymers; tri-block fluorinated thermoplastics; fluorinated polymers; hydrogenated nitrile rubber; fluoro-ethylene-vinyl ether copolymers; thermoplastic polyurethanes; thermoplastic olefins; styrene-ethylene-butylene-styrene block copolymers; and polyvinylidene fluoride homopolymers. The cathode material includes, for example, at least about 1% by weight (e.g., at least about 3% by weight) and/or up to about 5% by weight of one or more binders.

The cathode current collector can be formed, for example, of one or more metals and/or metal alloys. Examples of metals include titanium, nickel, and aluminum. Examples of metal alloys include aluminum alloys (e.g., 1N30, 1230) and stainless steel. The current collector generally can be in the form of a foil or a grid. The foil can have, for example, a thickness of up to about 35 microns and/or at least about 20 microns.

Cathode 16 can be formed by first combining one or more cathode active materials, conductive materials, and binders with one or more solvents to form a slurry (e.g., by dispersing the cathode active materials, conductive materials, and/or binders in the solvents using a double planetary mixer), and then coating the slurry onto the current collector, for example, by extension die coating or roll coating. The coated current collector is then dried and calendered to provide the desired thickness and porosity.

Anode 12 includes one or more alkali metals (e.g., lithium, sodium, potassium) as the anode active material. The alkali metal may be the pure metal or an alloy of the metal. Lithium is the preferred metal; lithium can be alloyed, for example, with an alkaline earth metal or aluminum. The preferred lithium metal is lithium alloyed with aluminum. The lithium alloy may contain, for example, at least about 500 ppm and up to about 5000 ppm (e.g., at least about 1000 ppm and up to 2000 ppm or at least about 1200 ppm and up to about 1700 ppm) of aluminum or other alloyed material. The lithium alloy can be incorporated into the battery in the form of a foil.

Alternatively, anode 12 can include a particulate material such as lithium-insertion compound, for example, LiC₆, Li₄Ti₅O₁₂, LiTiS₂. In these embodiments, anode 12 can include one or more binders. Examples of binders include polyethylene, polypropylene, styrene-butadiene rubbers, and polyvinylidene fluoride (PVDF). The anode composition includes, for example, at least about 1% by weight and up to about 9% by weight of binder. To form the anode, the anode active material and one or more binders can be mixed to form a paste which can be applied to a substrate. After drying, the substrate optionally can be removed before the anode is incorporated into the housing.

The anode material includes, for example, at least about 100% by weight and up to about 90% by weight of anode active material.

The electrolyte preferably is in liquid form. The electrolyte has a viscosity, for example, of at least about 0.2 cps (e.g., at least about 0.5 cps) and up to about 2.5 cps (e.g., up to about 2 cps or up to about 1.5 cps). As used herein, viscosity is measured as kinematic viscosity with a Ubbelohde calibrated visometer tube (Cannon Instrument Company; Model C558) at 22° C.

The electrolyte includes a sulfolane and 1,2-dimethoxyethane as solvents. The electrolyte optionally can include other solvents such as tetrahydrofuran and/or 1,3-dioxolane as well. The electrolyte includes, for example, at least about 1% by volume (e.g., at least about 5% by volume, at least about 10% by volume, or at least about 15% by volume) and/or, for example, up to about 30% by volume (e.g., up to about 25% by volume or up to about 20% by volume) of the sulfolane. The electrolyte includes, for example, at least about 35% by volume (e.g., at least 50% by volume, at least about 75% by volume, or at least about 80% by volume) and/or up to about 99% by volume (e.g., up to about 95% by volume or up to about 90% by volume) of the 1,2-dimethyloxyethane. Generally, sufficient 1,2-dimethoxyethane is included to reduce the viscosity of the electrolyte to the desired target.

The electrolyte may also include vinyl acetate and/or other viscosity-reducing monomers. The electrolyte includes, for example, at least about 0.5% by volume (e.g., at least about 2.5% by volume or at least 5% by volume) and/or up to about 30% by volume (e.g., up to about 20% by volume, up to about 15% by volume, or up to about 10% by volume) of vinyl acetate and/or other viscosity lowering monomers.

The electrolyte may include one or more salts. Preferred lithium salts include lithium bis(trifluoromethanesulfonyl)imide (LiTFSI), lithium trifluoromethanesulfonate (LiTFS), and lithium iodide (LiI). Other examples of lithium salts include lithium hexafluorophosphate (LiPF₆), lithium bis(oxalatoe)borate, and lithium bis(perfluoroethyl)sulfonimide (LiN(SO₂C₂F_{S})₂)/(LiB(C₂O₄)₂). Examples of other salts are described in Suzuki et al., U.S. Pat. No. 5,595,841 and in Totir et al., U.S. Pat. App. Pub. 2005/0202320 A1. The electrolyte includes, for example, at least about 0.1 M (e.g., at least about 0.5 M or at least about 0.7 M) and/or up to about 2 M (e.g., up to about 1.5 M or up to about 1.0 M) of the lithium salts.

The electrolyte may include other additional salts, for example, corrosion inhibitors such as lithium perchlorate (LiClO₄) and lithium nitrate (LiNO₃).

Positive lead 18 can include stainless steel, aluminum, an aluminum alloy, nickel, titanium, or steel. Positive lead 18 can be annular in shape, and can be arranged coaxially with the cylinder of a cylindrical cell. Positive lead 18 can also include radial extensions in the direction of cathode 16 that can engage the current collector. An extension can be round (e.g., circular or oval), rectangular, triangular or another shape. Positive lead 18 can include extensions having different shapes. Positive lead 18 and the current collector are in electrical contact. Electrical contact between positive lead 18 and the current collector can be achieved by mechanical contact. In some embodiments, positive lead 18 and the current collector can be welded together.

Separator 20 can be formed of any of the standard separator materials used in electrochemical cells. For example, separator 20 can be formed of polypropylene (e.g., nonwoven polypropylene, microporous polypropylene), polyethylene, and/or a polysulfone. Separators are described, for example, in Blasi et al., U.S. Pat. No. 5,176,968. The separator may also be, for example, a porous insulating polymer composite layer (e.g., polystyrene rubber and finely divided silica).

Case 22 can be made of, for example, one or more metals (e.g., aluminum, aluminum alloys, nickel, nickel plated steel, stainless steel) and/or plastics (e.g., polyvinyl chloride, polypropylene, polysulfone, ABS, polyamide).

Cap 24 can be made of, for example, aluminum, nickel, titanium, or steel.

While electrochemical cell 10 in FIG. 1 is a primary cell, in some embodiments a secondary cell can have a cathode that includes the above-described cathode active material. Primary electrochemical cells are meant to be discharged (e.g., to exhaustion) only once, and then discarded. Primary cells are not intended to be recharged. Primary cells are described, for example, in David Linden, Handbook of Batteries (McGraw-Hill, 2d ed. 1995). Secondary electrochemical cells can be recharged for many times (e.g., more than fifty times, more than a hundred times, or more). In some cases, secondary cells can include relatively robust separators, such as those having many layers and/or that are relatively thick. Secondary cells can also be designed to accommodate for changes, such as swelling, that can occur in the cells. Secondary cells are described, for example, in Falk & Salkind, “Alkaline Storage Batteries”, John Wiley & Sons, Inc. 1969, and DeVirloy et al., U.S. Pat. No. 345,124.

To assemble the cell, separator 20 can be cut into pieces of a similar size as anode 12 and cathode 16 and placed therebetween. Anode 12, cathode 16, and separator 20 are then placed within case 22, which is then filled with the electrolytic solution and sealed. One end of case 22 is closed with cap 24 and annular insulating gasket 26, which can provide a gas-tight and fluid-tight seal. Positive lead 18 connects cathode 16 to cap 24. Safety valve 28 is disposed in the inner side of cap 24 and is configured to decrease the pressure within electrochemical cell 10 when the pressure exceeds some predetermined value. Methods for assembling an electrochemical cell are described, for example, in Moses, U.S. Pat. No. 4,279,972, Moses et al., U.S. Pat. No. 4,401,735, and Kearney et al., U.S. Pat. No. 4,526,846.

Other configurations of an electrochemical cell can also be used, including, for example, the button or coin cell configuration, the prismatic cell configuration, the rigid laminar cell configuration, and the flexible pouch, envelope or bag cell configuration. Furthermore, an electrochemical cell can have any of a number of different voltages (e.g., 1.5 V, 3.0 V, 4.0 V). Electrochemical cells having other configurations are described, for example, in Berkowitz et al., U.S. Ser. No. 10/675,512, U.S. Pat. App. Pub. 2005/0112467 A1, and Totir et al., U.S. Pat. App. Pub. 2005/0202320 A1.

The following examples are meant to be illustrative and not to be limiting.

### EXAMPLE 1

An electrolyte was prepared by taking a stock solution made up of unsubstituted sulfolane, Aldrich, reagent grade (100 cc) and dimethoxyethane (Ferro Corp.) (400 cc). The sulfolane used in the stock solution is pre-treated, for example, with solid KMnO₄ overnight to oxidize impurities; after treatment the sulfolane is vacuum distilled to remove the impurities, potassium, and manganese, providing water white sulfolane.

In an argon-filled glove box, about 300 cc of the stock solution was added to a 500 ml. volumetric flask. To this flask was added 114.8 gram LiTFSI (3M) with stirring in small portions. The remainder of the stock solution was then added.

### EXAMPLE 2

The preparation of Example 3 was identical to that of Example 1 except that 71.75 grams of LiTFSI and 33.5 grams anhydrous LiI (Aesar) were used as the lithium salts.

### EXAMPLE 3

The preparation of Example 3 was identical to that of Example 1 except that 71.75 grams of LiTFSI (3M) and 39 grams anhydrous LiTFS (3M) were used as the lithium salts.

### EXAMPLE 4

Wound AA size cells were prepared using a lithium foil anode 0.152 mm in thickness, 39 mm wide and about 310 mm long, having an approximate weight of 1.0 grams (available from FMC Corp Lithco Div.) and cathode consisting of finely divided FeS2 89.2% (Chemetall) adhered to an aluminum foil (Allfoils) with small amounts of carbon (1% Super P MMM Carbon), graphite 7% (KS-6 Timcal Graphite) and a polystyrene binder (Kraton) 3% having a typical weight of about 6.7 grams and a thickness of 0.185 mm. The separator was Celgard 2500 (Hoechst-Celanese).

The electrolytes from Examples 1-3 were incorporated into AA size cells. From 1.9 to 2.2 grams of electrolyte were placed in each cell. The cells were then crimped, pre-discharged and the open circuit voltage and load voltage determined.

The cells were then discharged on an accelerated digital camera test consisting of applying a 1500 mW drain for 2 seconds followed by 650 mW for 28 seconds; this sequence repeating until the cell fails. Performance was measured by the number of pulses until the 1500 mW load voltage reached 1.05 V. The results are provided in Table 1.

TABLE 1

| | | | Pulses to | |
|---|---|---|---|---|
| Electrolyte | Solvents | Salt | 1.05 V | Pulses to 0.9 V |
| 1 | 20 S/80 DME | LiTFSI | 536(10) | 593(14) |
| 2 | 20 S/80 DME | LiTFSI/LiI | 507(22) | 584(11) |
| 3 | 20 S/80 DME | LiTFSI/LiTFS | 539(7) | 602(14) |

### Other Embodiments

While certain embodiments have been described, other embodiments are possible. For example, the embodiment described above uses an electrolyte including a sulfolane and 1,2-dimethoxyethane. Other embodiments employ electrolytes that include the sulfolane but not the 1,2-dimethoxyethane. The electrolyte also includes a lithium salt, preferably consisting of lithium bis(trifluoromethanesulfonyl)imide. The quantities of sulfolane and the lithium salt can be, for example, those discussed previously. The electrolyte can be used, for example, in batteries including any of the components or ingredients discussed previously.

All references, such as patent applications, publications, and patents, referred to herein are incorporated by reference in their entirety.

Other embodiments are in the claims.

What is claimed is:

1. A battery, comprising a housing, and within the housing:
(a) an anode comprising a lithium alloy;
(b) a cathode comprising a cathode active material selected from the group consisting of transition metal polysulfides having the formula M1ₐM2_{b}Sₙ, wherein M1 and M2 are transition metals, a+b is at least 1, and n is at least 2×(a+b); and
(c) an electrolyte comprising from 1% to 30% by volume of a sulfolane and from 35% to 99% of 1,2-dimethoxyethane.

2. The battery of claim 1, wherein the electrolyte includes from 5% to 20% by volume of the sulfolane and at least 75% by volume of the 1,2-dimethoxyethane.

3. The battery of claim 1, wherein the electrolyte includes less than 25% by volume of the sulfolane.

4. The battery of claim 1, wherein the electrolyte is substantially free of carbonate esters.

5. The battery of claim 1, wherein the electrolyte includes less than 10% by volume of a solvent other than the sulfolane and the 1,2-dimethoxyethane.

6. The battery of claim 1, wherein the electrolyte includes less than 2% by volume of a solvent other than the sulfolane and the 1,2-dimethoxyethane.

7. The battery of claim 1, wherein the electrolyte has a viscosity of from 0.2 cps to 2.5 cps.

8. The battery of claim 1, wherein the electrolyte has a viscosity of from 0.5 cps to 1.5 cps.

9. The battery of claim 1, wherein the electrolyte further comprises vinyl acetate.

10. The battery of claim 9, wherein the electrolyte includes from 0.5% to 20% by volume of the vinyl acetate.

11. The battery of claim 1, wherein the lithium is alloyed with aluminum.

12. The battery of claim 11, wherein the lithium alloy includes from 500 ppm to 5000 ppm of aluminum.

13. The battery of claim 12, wherein the lithium alloy includes from 1000 ppm to 2000 ppm of aluminum.

14. The battery of claim 12, wherein the lithium alloy includes from 1200 ppm to 1700 ppm of aluminum.

15. The battery of claim 1, wherein the cathode active material is iron disulfide.

16. The battery of claim 1, wherein the lithium is alloyed with aluminum, the cathode active material is iron disulfide, and the electrolyte includes from 5% to 20% by volume of the sulfolane and at least 70% by volume of the 1,2-dimethoxyethane.

17. The battery of claim 1, wherein the sulfolane is unsubstituted sulfolane.

18. The battery of claim 1, wherein the electrolyte further comprises a lithium salt.

19. The battery of claim 18, wherein the lithium salt is lithium bis(trifluoromethanesulfonyl)imide.

20. The battery of claim 17, wherein the electrolyte includes from 0.2 M to 1.0 M of the lithium bis(trifluoromethanesulfonyl)imide.

21. The battery of claim 17, wherein the electrolyte further includes lithium iodide.

22. The battery of claim 16, wherein the lithium salt is lithium iodide.

23. A battery, comprising a housing, and within the housing:
(a) an anode comprising a lithium alloy;
(b) a cathode comprising a cathode active material selected from the group consisting of transition metal polysulfides having the formula M1ₐM2_{b}Sₙ, wherein M1 and M2 are transition metals, a+b is at least 1, and n is at least 2×(a+b); and
(c) an electrolyte comprising from 1% to 30% by volume of a sulfolane and lithium bis(trifluoromethanesulfonyl)imide.

24. The battery of claim 21, wherein the electrolyte comprises from 5% to 25% by volume of the sulfolane.
